(19) United States
(12) Patent Application Publication
(10) Pub. No.: US 2013/0124745 A1
(43) Pub. Date: May 16, 2013

(54) METADATA-DRIVEN BILERATAL INTERACTION BETWEEN AN IPTV CONTROL SERVER AND A MEDIA SERVER DURING CONTENT STREAMING

(71) Applicants: Edoardo GAVITA, Laval (CA); Zhongwen ZHU, Saint-Laurent (CA)

(72) Inventors: Edoardo GAVITA, Laval (CA); Zhongwen ZHU, Saint-Laurent (CA)

(73) Assignee: TELEFONAKTIEBOLAGET L M ERICSSON (PUBL)

(21) Appl. No.: 13/297,915

(22) Filed: Nov. 16, 2011

(51) Int. Cl. G06F 15/16

(52) U.S. Cl. 709/231

(57) ABSTRACT

Temporal metadata associated with media content drives bilateral interaction between a media server and an IPTV control server during streaming of that content from the media server. Specifically, the metadata is encoded to indicate, and associate together, a defined point in the media content's presentation timeline and a defined operation, such as the fetching of supplemental media content or the sending of a notification. The media server inspects this metadata and, based on that inspection, notifies the IPTV control server when the defined point has been reached in the context of streaming the media content. Responsive to receiving this notification, the IPTV control server inspects the metadata to identify the operation associated with the notified point in the content's timeline. The IPTV control server then initiates the performance of the identified operation and returns a response to the media server that pertains to such performance.

### TECHNICAL FIELD

The present invention generally relates to the streaming of media content over IP Television (IPTV) systems, and in particular to the interaction between an IPTV control server and a media server during such streaming.

### BACKGROUND

An IPTV service provider delivers a digital media service to subscribers using Internet Protocol over a network infrastructure, such as IP Multimedia Service (IMS), in lieu of traditional broadcast or cable delivery. The service may deliver either live media content or stored media content (e.g., Video-on-Demand).

Stored media content, in particular, may be received by the IPTV service provider from any number of content providers. As part of this ingestion process, the IPTV service provider normalizes or otherwise prepares metadata that describes the received content, so that the content can be discovered and accessed by subscribers. In this regard, an IPTV control server functions as a single point of contact for subscribers to discover media content (e.g., via an electronic service guide generated from content metadata), to initiate the streaming of selected content from a media server, and to otherwise control the IPTV service.

This integral involvement of the IPTV control server as middleware, however, does not extend to actual content delivery, as media content is delivered directly from a media server to a subscriber. Moreover, any interaction between the IPTV control server and the media server during content streaming is effectively one-way in the sense that the control server simply sends control commands to the media server. Limiting this interaction between the IPTV control server and the media server proves to in turn limit enhancements to IPTV services.

### SUMMARY

Teachings herein advantageously cultivate bilateral interaction between a media server and an IPTV control server during content streaming. Driven by temporal metadata, this bilateral interaction fosters enhanced IPTV services that are intimately tied to the underlying subject matter of streamed media content and/or the user consuming that content.

More particularly, a metadata preparation server in one or more embodiments herein identifies media content that is to be available for streaming from a media server to client devices. The metadata preparation server then obtains information that specifies a defined point within a presentation timeline of the identified media content at which the IPTV control server is to initiate the performance of a defined operation. This defined point may be specified in terms of Normal Play Time (NPT). And the defined operation to be initiated by the IPTV control server may be the dynamic fetching of supplemental media content, the sending of a notification, or the like. Regardless, the metadata preparation server encodes one or more elements within metadata associated with the media content to indicate, and associate together, the defined point and the defined operation.

With the content's metadata associating a defined point in the content's timeline with a defined operation to be initiated by the IPTV control server, the metadata drives the media server and the IPTV control server to engage in bilateral interaction at the defined point. Specifically, the media server inspects one or more elements within the metadata and, based on that inspection, determines that the media server is to notify the IPTV control server when a defined point in the media content has been reached during streaming of the content to a particular client device. Correspondingly, while streaming the content to the client device, the media server notifies the IPTV control server upon the defined point being reached.

Responsive to receiving this notification of the defined point, the IPTV control server inspects one or more elements with the content's metadata to identify an operation associated with that defined point. Such metadata may be acquired at the IPTV control server from the metadata preparation server upon ingestion of the content, or from the media server upon notification of the defined point. Regardless, the IPTV control server correspondingly initiates the performance of the identified operation, in accordance with the metadata. Such initiation may involve the IPTV control server itself performing the identified operation, the IPTV control server directing another node to perform the operation, or any combination thereof. Processing then includes sending the media server a response that pertains to such performance, such as a result of the performance or at least an acknowledgement of the performance.

In some embodiments, the operation performed entails the dynamic fetching of supplemental media content, such as an advertisement. In this case, the IPTV control server initiates the fetching of supplemental media content and returns that content so that the media server will introduce it into the media stream at the defined point.

Notably, at least some embodiments exploit the association defined by the temporal metadata between a particular point in the media stream and the fetching of supplemental content, in order to fetch content that is intimately related to the underlying subject matter of the stream at that point. The intelligence responsible for exploiting this association may be located at either the metadata preparation server or the IPTV control server. In either case, intelligence at the IPTV control server may additionally or alternatively tailor fetching of the supplemental content to the specific user consuming the media stream, e.g., based on a user profile retrieved for that user.

In other embodiments, the operation performed entails the sending of a notification. For example, the notification sent may indicate that the media content being streamed to a client device has been or is being consumed. Such notification may facilitate charging of the client device's user for consumption of particular media, updating the user's social media website to indicate the user's consumption, or the like.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of an IPTV system according to one or more embodiments.

FIG. 2 is a logic flow diagram of processing performed by a metadata preparation server for preparing metadata to drive bilateral interaction between a media server and an IPTV control server during content streaming, according to one or more embodiments.

FIG. 3 is a logic flow diagram of processing performed by a media server for metadata-driven bilateral interaction with a control server during content streaming, according to one or more embodiments.

FIG. 4 is a logic flow diagram of processing performed by an IPTV control server for metadata-driven bilateral interaction with a media server during content streaming, according to one or more embodiments.

FIGS. 5 and 6 are call flow diagrams for media content ingestion and media content playback, respectively, according to one or more embodiments.

FIG. 7 is a block diagram of a server configured to implement the processing shown in any of FIGS. 2-4, according to one or more embodiments.

FIG. 8 is a block diagram of an IPTV control server controller configured to implement the processing shown in FIG. 4, according to one or more embodiments.

FIG. 9 is a block diagram of a metadata preparation controller configured to implement the processing shown in FIG. 2, according to one or more embodiments.

FIG. 10 is a block diagram of a media server controller configured to implement the processing shown in FIG. 3, according to one or more embodiments.

### DETAILED DESCRIPTION

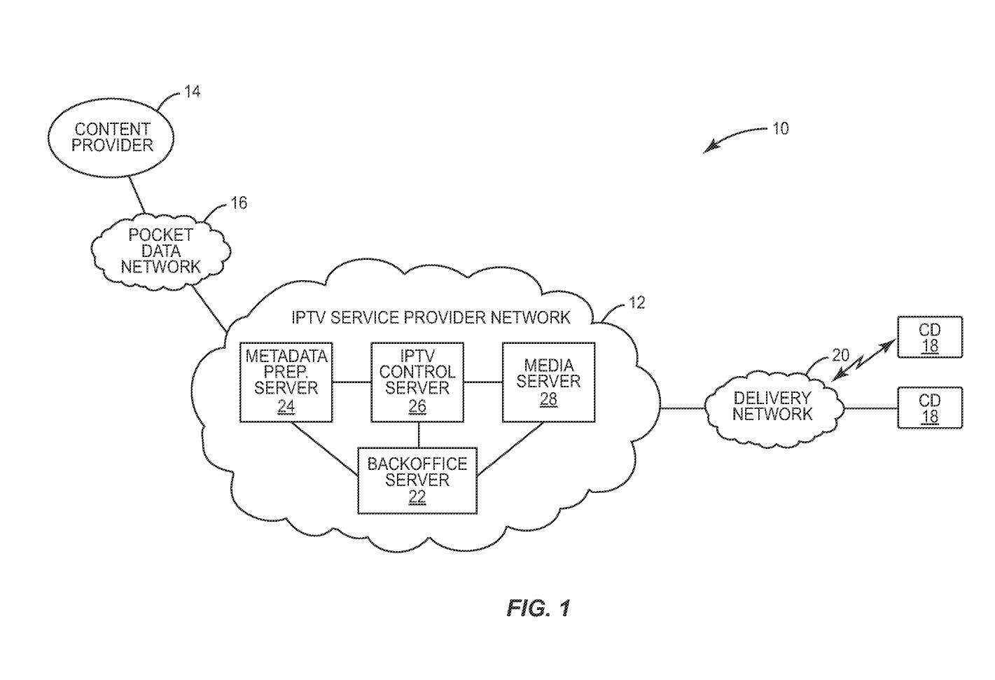

FIG. 1 depicts an IPTV system 10 according to one or more embodiments. In this system 10, an IPTV service provider's network 12 receives media content from one or more content providers 14 via a packet data network 16 (e.g., the Internet). The IPTV service provider network 12 then delivers that content to the client devices 18 of IPTV subscribers, using the Internet Protocol, over a delivery network 20.

More particularly, a backoffice server 22 within the IPTV service provider network 12 controls ingestion of received media content into the network 12. In this regard, once a metadata preparation server 24 normalizes or otherwise prepares metadata that describes the received content, the backoffice server 22 informs an IPTV control server (CS) 26 about that content and provisions the content in a media server 28. Client devices 18 then interact with the IPTV CS 26 to discover media content and to initiate the streaming of selected content from the media server 28.

Notably, rather the IPTV CS 26 simply sending commands to the media server 28, as is conventional, the IPTV CS 26 and the media server 28 engage in bilateral interaction during content streaming. Driven by temporal metadata prepared by the metadata preparation server 24, this bilateral interaction fosters enhanced IPTV services that are intimately tied to the underlying subject matter of the streamed media content and/or the subscriber consuming that content.

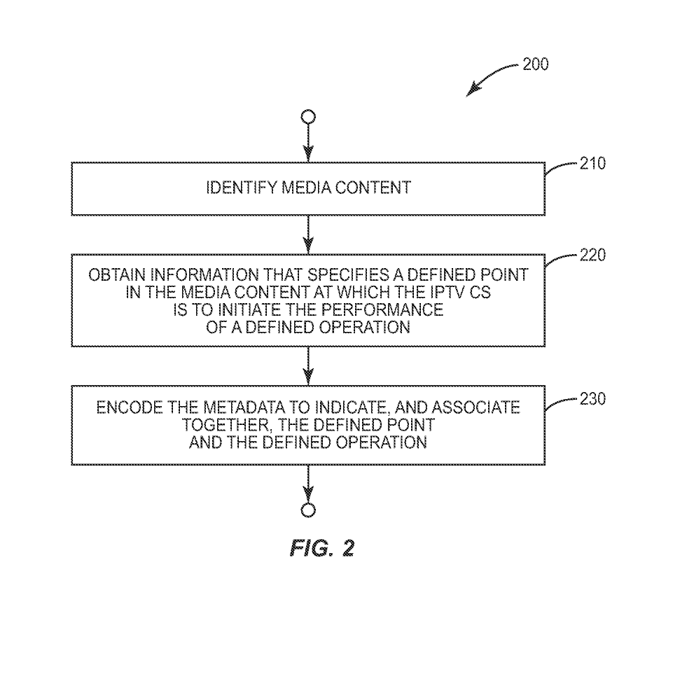

FIG. 2 illustrates processing 200 performed by the metadata preparation server 24 in this regard. As shown in FIG. 2, processing includes identifying media content that is to be available for streaming from the media server 28 (Block 210). Processing then includes obtaining information that specifies a defined point within a presentation timeline of the identified media content at which the IPTV CS 26 is to initiate performance of a defined operation (Block 220). The defined point may be specified in terms of Normal Play Time (NPT). And the defined operation to be initiated by the IPTV CS 26 at the defined point may be, for instance, the dynamic fetching of supplemental media content, the sending of a notification, or the like. Regardless, processing further includes encoding one or more elements within metadata associated with the media content to indicate, and associate together, the defined point and the defined operation (Block 230).

As elaborated on below, the metadata preparation server 24 may obtain the information specifying the defined point and the defined operation in any number of ways. In some embodiments, for example, the metadata preparation server 24 acquires such information via a user interface. In this case, an operator of the user interface defines the particular point in the content's timeline at which the IPTV CS 26 is to initiate the operation, and also defines that operation. In other embodiments, the metadata preparation server 24 acquires the information from memory, e.g., as stored default values for the defined point and operation. In yet other embodiments, the metadata preparation server 24 acquires at least some of the information via one or more network interfaces, based upon a service-level agreement (SLA) between the IPTV service provider network 12 and the content provider 14. For example, these one or more network interfaces may include a client-server interface or a server-to-server interface, according to Representational State Transfer (REST) or Hypertext Transfer Protocol (HTTP) standards.

Also, the metadata preparation server 24 may temporally tie the defined operation to the media content in this way using any number of approaches. In some embodiments, for instance, the metadata preparation server 24 establishes the temporal relationship by indicating the defined operation within metadata elements that are encoded into the header of a content frame placed at or near the defined point. Hence, the metadata elements implicitly associate the defined operation with the defined point by their literal placement within the content stream, rather than by any explicit timing information. In other embodiments, though, the metadata preparation server 24 establishes the temporal relationship by indicating the defined operation within metadata elements that reference the defined point using explicit timing information. Such metadata elements therefore need not be placed anywhere particular within the stream to temporally tie the defined operation to the defined point.

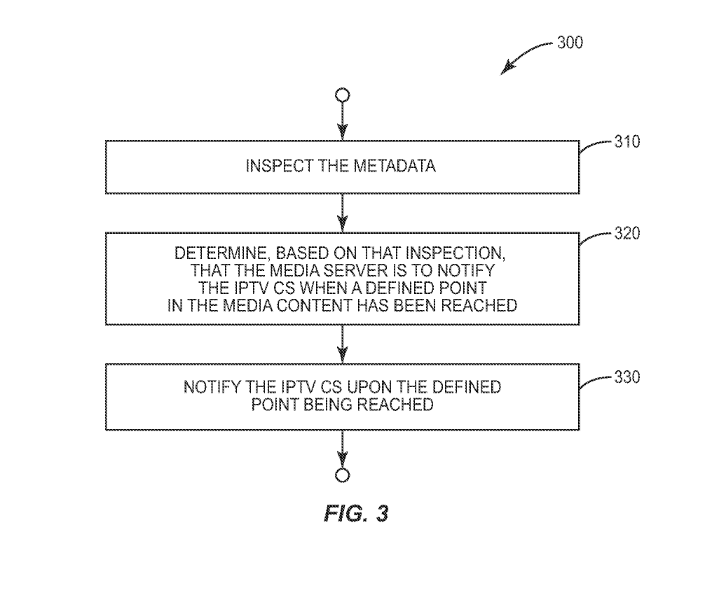

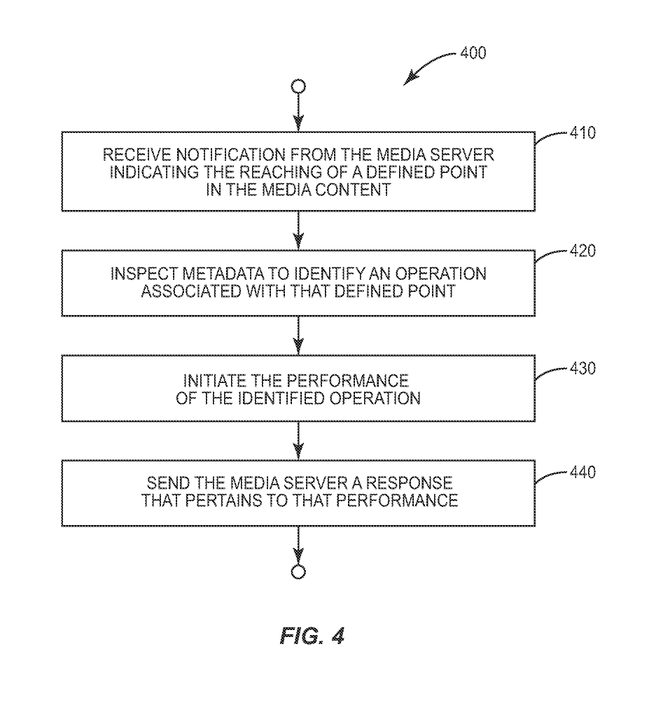

With the content's metadata associating a defined point in the content's timeline with a defined operation to be initiated by the IPTV CS 26, the metadata drives the media server 28 and the IPTV CS 26 to engage in bilateral interaction at the defined point. Specifically, the metadata triggers the media server 28 to notify the IPTV CS 26 when that defined point has been reached in the streaming of the content to a client device 18. And the metadata drives the IPTV CS 26 to initiate the performance of the defined operation upon receiving such notification from the media server 28. FIGS. 3 and 4 illustrate processing performed by the media server 28 and IPTV CS 26, respectively, in this regard.

As shown in FIG. 3, processing 300 at the media server 28 includes inspecting one or more elements within metadata associated with the media content (Block 310). Such inspection may entail real-time reading of metadata elements that are encoded into the headers of content frames being streamed and that thereby implicitly indicate timing information. Or, inspection may include advanced evaluation of metadata elements that include explicit timing information, apart from their placement within the content stream. Regardless, processing further includes determining, based on that inspection, that the media server 26 is to notify the IPTV CS 26 when a defined point in the media content has been reached during streaming of the content to a client device 18 (Block 320). Finally, while streaming the content to the client device 18, processing entails notifying the IPTV CS 26 upon the defined point being reached (Block 330).

FIG. 4 depicts corresponding processing 400 performed at the IPTV CS 26. Such processing includes receiving notification from the media server 28 indicating that a defined point within a presentation timeline of the media content has been reached during streaming (Block 410). Responsive to receipt of that notification, processing 400 entails inspecting one or more elements within metadata associated with the media content to identify an operation associated with that defined point (Block 420). Such metadata may be acquired at the IPTV CS 26 from the metadata preparation server 24 upon ingestion of the content, or from the media server 28 upon notification of the defined point. Regardless, processing then includes initiating the performance of the identified operation, in accordance with the metadata (Block 430). Such initiation may involve the IPTV CS 26 itself performing the identified operation, the IPTV CS 26 directing another node to perform the operation, or any combination thereof. Regardless, processing then includes sending the media server 28 a response that pertains to such performance, such as a result of the performance or at least an acknowledgement of the performance (Block 440).

In some embodiments, for example, the operation performed entails the dynamic fetching of supplemental media content, such as an advertisement. In this case, when the media server 28 notifies the IPTV CS 26 about the occurrence of a defined point in the stream, the IPTV CS 26 initiates the fetching of supplemental media content and returns that content (or a Uniform Resource Locator, URL, for that content) so that the media server 28 will introduce it into the media stream at the defined point (e.g., as a picture-in-picture or as a full screen media insert). The metadata preparation server 24 prepares the metadata to drive this fetching by encoding the metadata to indicate that the operation to be performed at the defined point is supplemental media content fetching and to identify a node via which the supplemental content is to be fetched (e.g., in terms of a URL).

This node may be a generic portal to different supplemental content options. In at least some embodiments, the generic portal autonomously selects the supplemental content on its own, without knowledge of the content being streamed, meaning that it inevitably returns supplemental content that is unrelated to the underlying subject matter of the streamed content. Other embodiments, however, exploit the association defined by the temporal metadata between a particular point in the media stream and the fetching of supplemental content, in order to fetch content that is intimately related to the underlying subject matter of the stream at that point. For instance, where the underlying subject matter of a movie at a particular point concerns pets, the supplemental media content is dynamically fetched to also relate to pets. Of course, the granularity with which the supplemental content is tailored in this way may alternatively be broader in the sense that the content is fetched to more generally relate to underlying subject matter common throughout the streamed media content as a whole, rather than the subject matter at a particular point in the stream. Regardless, such tailoring of the supplemental content can be accomplished by passing or otherwise providing the generic portal with parameters that dictate or suggest what the supplemental content returned should be.

In at least one embodiment, the metadata preparation server 24 encodes one or more elements in the metadata to indicate such parameters (e.g., as parameters in the URL of the portal). The metadata preparation server 24 may acquire or otherwise obtain these parameters in any number of ways, as part of the process by which the media content is ingested into the network 12.

As one example, the metadata preparation server 24 may obtain the parameters from a user interface. In this case, a person associated with the IPTV service provider's network 12 inspects the media content as it is ingested into the system, such as by inspecting metadata elements that describe the content's title, a summary of the content's subject matter, the content's genre, etc. For finer granularity, the person may additionally inspect the media content at a defined point for which the person is determining parameters, in order to determine what subject matter exists at that point. Regardless, based on that inspection, the person operates a user interface into the metadata preparation server 24 in order to define values for metadata elements associated with the parameters to be passed to the generic portal. For example, the person may generally define the URL of the portal as www.genericportal.com/subject?pets in order to indicate to the generic portal that the subject matter of the returned supplemental media content should relate to pets. Alternatively, where the person desires particular supplemental content that he or she already knows is related to pets, the person may more specifically define the URL of the portal as www.genericportal.com/contentID?1234 in order to direct the generic portal to return the pet-related supplemental media content identified by the number ‘1234.’

As another example, the metadata preparation server 24 may automatically obtain the parameters based on a sophisticated inspection and evaluation of existing content metadata according to predefined rules. Such rules may map, for instance, subject matter recognized in metadata that describes the content (e.g., title, summary, etc.) to parameters to pass to the generic portal (e.g., if the content's summary contains the keyword ‘dog’ or ‘cat,’ pass the parameter ‘pets’ to the portal).

In other embodiments, the metadata preparation server 24 simply identifies the generic portal in the metadata, without additionally encoding the metadata to indicate parameters to pass to the portal. In this case, the metadata preparations server 24 still encodes the metadata to define the time(s) at which the IPTV CS 26 is to initiate supplemental content fetching (e.g., based on default time intervals, such as every 10 minutes). But, rather than the metadata preparation server 24 performing the sophisticated metadata inspection described above, the IPTV CS 26 performs that inspection in order to determine parameters to pass to the portal. The IPTV CS 26 may perform the inspection on-the-fly, responsive to the media server's notification of the defined point, or in advance of such notice.

Shifting this intelligence to the IPTV CS 26 fits well with other embodiments envisioned herein whereby the IPTV CS 26 tailors the fetching of supplemental content to the specific user consuming the media stream, alternatively or in addition to tailoring fetching to the underlying subject matter of the media stream. In these embodiments, the IPTV CS 26 determines an identity of the user to which the media server 28 is streaming the media content, e.g., based on a user identity or session identifier received from the media server along with the notification of the defined point being reached. The IPTV CS 26 then retrieves a profile stored for the identified user and identifies one or more parameters in the retrieved profile that are associated with the user. Such parameters may include general characteristics that describe the user (e.g., the user's gender, age, etc.) or more specific topics of interest to the user (e.g., cars, pets, or the like). Regardless, the IPTV CS 26 passes those one or more parameters to the generic portal identified within the metadata for the fetching of supplemental media content that is specifically tailored to the user. If these user-related parameters are passed along with subject-matter-related parameters, the generic portal may return supplemental content that is related to as many parameters as possible.

In still other embodiments, the operation defined in the metadata and initiated by the IPTV CS 26 includes the sending of a notification rather than the fetching of supplemental media content. Again, the metadata preparation server 24 prepares the metadata to drive this notification by encoding the metadata to indicate that the operation to be performed at the defined point is the sending of a notification and to identify a node to which the notification is to be sent (e.g., in terms of a URL).

In at least one embodiment, the notification sent indicates that the media content being streamed to a client device 18 has been or is being consumed. For example, the metadata may specify that such a notification is to be sent to a node in a charging system, so that the user of the client device 18 can be charged or otherwise billed for consuming that content. As another example, the metadata may specify that such a notification is to be sent to a node of a social media system, so that friends of the device's user can be updated about what media content the user is consuming.

Accordingly, the IPTV CS 26 in such examples generates the notification to include an identity of the user of the client device 18, an identifier of the content being consumed, and an identity of a provider of the content. One or more of these values may be received from the media server 28 along with the notification that the defined point has been reached. Particularly in this case, therefore, the IPTV CS 26 in some embodiments first verifies the content provider's identity before sending the consumption notification. Regardless, such notifications advantageously provide real-time information indicating which particular users consumed a particular media stream, the length of time such consumption lasted (since the consumption notifications are temporally tied to the content's timeline), and the like.

In at least one other embodiment, the notification indicates that particular supplemental media content (e.g., a particular advertisement) has been or is being consumed, as a sort of delivery report, rather than indicating that the streamed media content is being consumed. As discussed above, this supplemental content may be dynamically fetched, meaning that the metadata drives both the dynamic fetching of supplemental content and the notification of that content's consumption upon the occurrence of the defined point (e.g., by specifying one node, or URL, from which to fetch the supplemental content and another node, or URL, to which the notification is to be sent). The sending of this notification may be triggered upon the user of the client device 18 simply viewing the supplemental contact, or may only be triggered upon the user interacting with that content.

Where the supplemental content is clickable, for instance, the notification may be triggered by the user clicking on the content. Particularly in this case, the client device 18 actually sends the notification, rather than the IPTV CS 26. But, the IPTV CS 26 effectively initiates the client device's sending of the notification by adding metadata to the fetched supplemental content that renders the content clickable and that directs the client device 18 to a particular node or URL (the one specified in the streamed media content's metadata) upon such clicking.

In yet other embodiments, the IPTV CS 26 may be pre-configured with the identity of this node or URL, rather than the node or URL being specified in the streamed media content's metadata. Alternatively, the IPTV CS 26 may receive the identity of the node or URL responsive to fetching the supplemental content. Either way, the IPTV CS 26 effectively initiates the client device's sending of the notification by adding the above-mentioned metadata to the supplemental content before sending that content to the client device 18. Regardless of the particular manner in which the notification sending is initiated, the notification advantageously provides a supplemental content provider (e.g., an advertiser) real-time information pertaining to user interest in (and therefore the effectiveness of) supplemental content.

Those skilled in the art will of course appreciate that the above examples just demonstrated the ability of bilateral interaction between the IPTV CS 26 and the media server 28 to better tailor IPTV services, e.g., to particular streamed content and/or to a particular user consuming that content. Accordingly, bilateral interaction in other examples may not trigger the same type of operations described above (e.g., the fetching of supplemental content or the sending of a notification. Generally, therefore, the metadata may drive the IPTV CS 26 to perform any type of operation.

Those skilled in the art will further understand that the above description was simplified in a number of respects purely for purposes of illustration. For example, although the above description primarily discussed the performance of a single operation at a single defined point, the metadata preparation server 24 may encode the metadata to drive any number of operations at any number of defined points. Moreover, although the above description primarily discussed the streaming of media content to a single user's client device 18, the media server 18 may stream that content to any number of devices 18 simultaneously. In such a case, the IPTV CS 26 may tailor the same operations to different users based on different user profiles retrieved for those users.

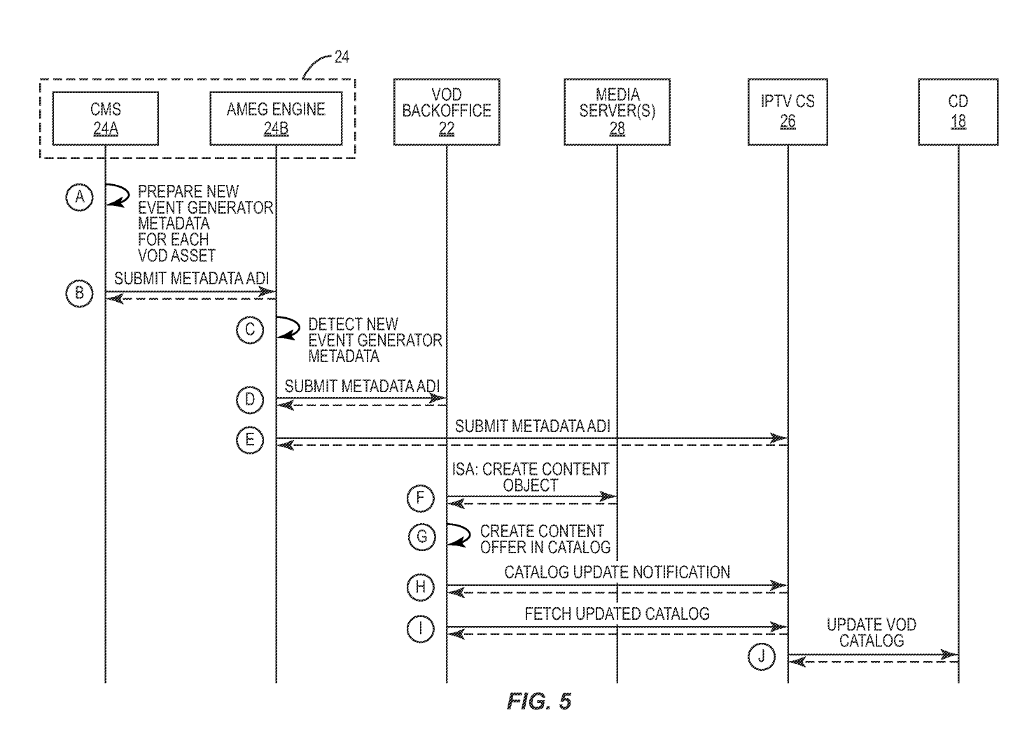

Finally, those skilled in the art will appreciate that no particular communication standard or protocol is required for practicing embodiments herein. Nonetheless, various embodiments herein encode media content according to Motion Picture Experts Group (MPEG)-based standards, encode content metadata in Extensible Markup Language (XML) format, perform operations using the Hypertext Transfer Protocol (HTTP), distribute media content using the CableLabs Asset Distribution Interface (ADI), and control media content streaming using the Real Time Streaming Protocol (RTSP). FIGS. 5 and 6 illustrate specific examples of these embodiments in the context of content ingestion and content playout, respectively.

As shown in FIG. 5, the metadata preparation server 24 in these embodiments may be functionally or physically split into a content management system (CMS) 24A and an ADI Metadata Event Generator (AMEG) engine 24B. The CMS 24A normalizes or otherwise prepares metadata as is known in the art, but also adds new metadata headers associated with the metadata elements discussed above (e.g., for defining the defined point and defined operation) (Step A). Having added these new metadata headers, the CMS 24A submits the metadata ADI to the AMEG engine 24B (Step B). The AMEG engine 24B detects the new metadata headers and defines values for those headers as discussed above, e.g., via a user interface or via default values (Step C). Such may entail, for instance, inserting system-wide URLs that identify a node via which supplemental content is to be fetched. Regardless, the AMEG engine 24B then sends the metadata ADI to the backoffice server 22, which in this example is shown as a video-on-demand (VOD) backoffice (Step D). The AMEG engine 24B may optionally also send the metadata ADI to the IPTV CS 26 (Step E), e.g., in embodiments where the media server 28 does not itself send the metadata to the IPTV CS 26 as part of sending a notification to the CS 26.

Having received the metadata ADI, the VOD backoffice 22 sends an Industry Standard Architecture (ISA) content message to the media server 28 that is associated with the media content to be streamed by that server 28 (Step F). In doing so, the VOD backoffice 22 sets a flag in the message to indicate to the media server 28 that the content's metadata one or more defines points at which the media server 28 is to notify the IPTV CS 26 about. As described below, the media server 28 will inspect the metadata for these defined points, responsive to receiving this flag.

The VOD backoffice 22 then proceeds as normal, by updating its catalog of available media content to include the content just ingested (Step G), notifying the IPTV CS 26 about that update (Step H), and then sending the updated catalog to the IPTV CS 26 upon request (Step I). Finally, the client devices 18 receive the updated catalog from the IPTV CS 26 (Step J).

As shown in FIG. 6, when a user selects media content to consume (Step K), the client device 18 sends a request to the IPTV CS 26 for a URL to that content (Step L). In this example, though, the enhanced IPTV services provided by the new metadata require a subscription or are otherwise restricted to certain users. Accordingly, the IPTV CS 26 performs access control with respect to the request received from the client device 18, by selectively activating or de-activating the enhanced IPTV services depending on whether or not a user profile for the user indicates that the user is subscribed to the enhanced IPTV services (Step M). If the user is subscribed to the enhanced IPTV services, and those services are offered for the selected content, the IPTV CS 26 includes a service activation flag in the requested content URL provided to the client device 18 (Step N). The client device 18 is configured to include this new flag in the RTSP setup request and play request that the device 18 sends to the media server 28 for requesting the playout of the selected media content (Steps O and P).

The media server 28 recognizes the service activation flag in the RTSP requests and activates the enhanced IPTV services with respect to the particular user of client device 18. In that regard, as the media server 28 streams the selected content to the client device (Step Q), the media server 28 monitors for the occurrence of the defined points specified in the content's metadata, as described above.

When one of those defined points occurs in the stream to the client device 18, the media server 28 notifies the IPTV CS 26 about that occurrence (Step R). In doing so, the media server may pass the IPTV CS 26 a session identifier for the streaming session associated with the user, an identity of the user, or the like, and may also pass the IPTV CS 26 the selected content's metadata. Regardless, when the IPTV CS 26 receives that notification, it inspects the content's metadata to determine the operation that the metadata associates with the notified point in the stream. Upon initiating the performance of that operation, the IPTV CS 26 returns a response to the media server 28 that pertains to the performance (Step S). Such notification and response may repeat for any additional defined points specified in the metadata.

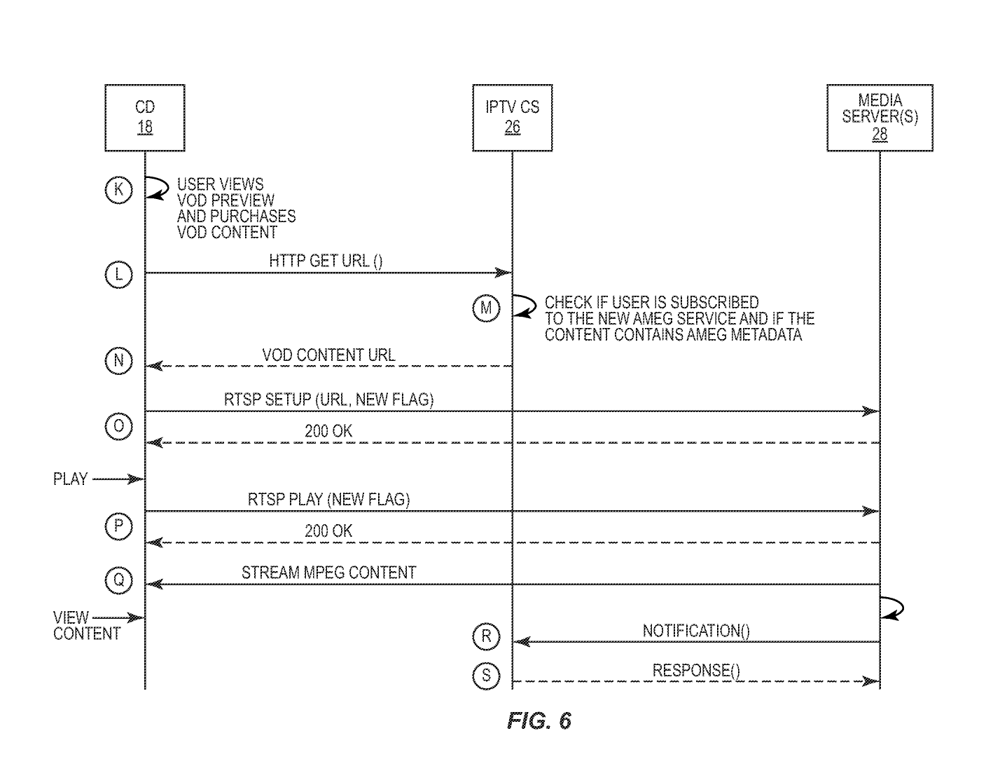

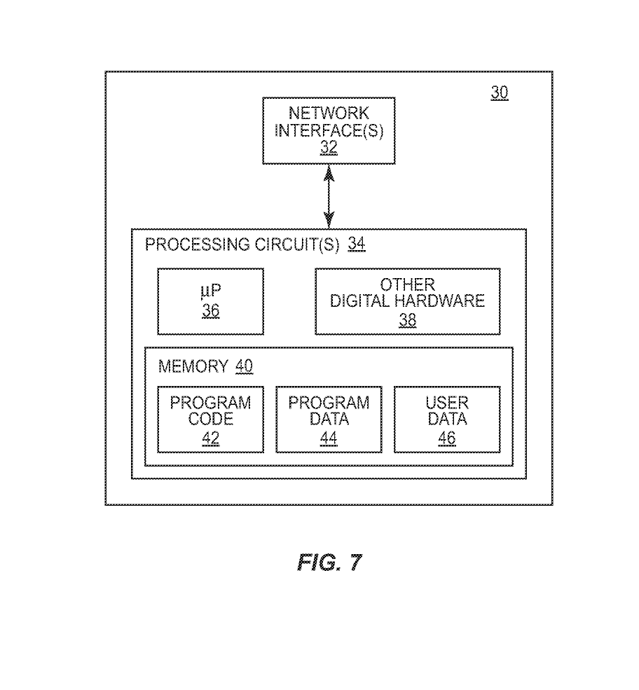

Apparatus configured to carry out the techniques described above are illustrated in FIGS. 7-10. FIG. 7 is a block diagram of a server 30 configured according to any of the techniques disclosed herein. Regardless of whether server 30 is the metadata preparation server 24, the IPTV control server 26, or the media server 28, the server 30 includes one or more network interfaces 32 and one or more processing circuits 34. The one or more network interfaces 32 use known signal processing techniques, typically according to one or more communication standards, for communicatively coupling the server 30 to other network nodes in the IPTV service provider network 12 as well as nodes in other networks. That is, the one or more network interfaces 32 are configured to format digital data and condition a communication signal, from that data, for transmission over a communications link.

The one or more processing circuits 34 are configured to extract digital data from the one or more network interfaces 32 for processing, and to generate digital data for transmission over the one or more network interfaces 32. More particularly, the one or more processing circuits 34 comprise one or several microprocessors 36, digital signal processors, and the like, as well as other digital hardware 38 and memory circuit 40. Memory 40, which may comprise one or several types of memory such as read-only memory (ROM), random-access memory, cache memory, flash memory devices, optical storage devices, etc., stores program code 42 for executing one or more data communications protocols and for carrying out one or more of the techniques described herein. Memory 40 further stores program data 44 and user data 46 for carrying out such techniques, and also stores various parameters and/or other program data for controlling the operation of the server 30. Of course, any of such data may alternatively be retrieved from one or more other network nodes, via the one or more network interfaces 32, such as in a cloud environment.

Of course, not all of the steps of the techniques described herein are necessarily performed in a single microprocessor or even in a single module. Thus, FIG. 8 presents a more generalized view of a server 30 configured to carry out the method shown in FIG. 4. This server 30 may have a physical configuration that corresponds directly to processing circuits 34, for example, or may be embodied in two or more modules or units. In either case, the server 30 includes an IPTV CS controller 48 that is configured with modules or sub-circuits to carry out operations in accordance with the method in FIG. 4. These units are pictured in FIG. 8 as a notification controller 50, a metadata inspector 52, and an operation initiator 54.

The notification controller 50 receives notifications from the media server 28 indicating the reaching of a defined point in the media content being streamed to a client device 18. The metadata inspector 52, responsive to the notification controller 50, then inspects the content's metadata to identify an operation associated with that defined point. Finally, the operation initiator 54 initiates the performance of the identified operation, and sends the media server 28 a response that pertains to that performance.

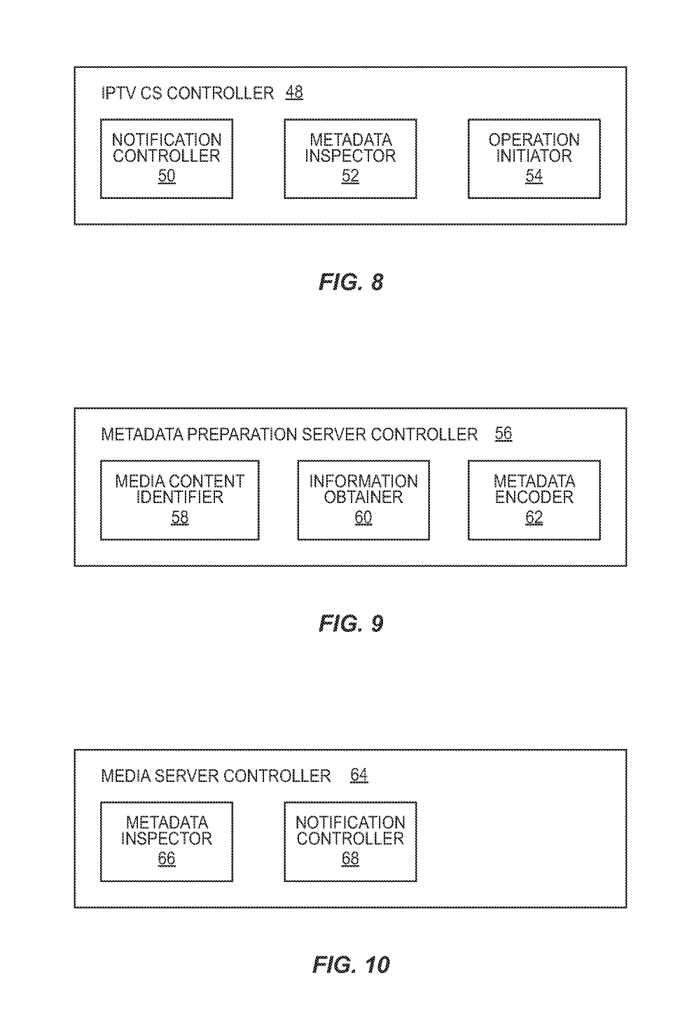

FIG. 9, by contrast, presents a more generalized view of a server 30 configured to carry out the method shown in FIG. 2. This server 30 may likewise have a physical configuration that corresponds directly to processing circuits 34, for example, or may be embodied in two or more modules or units. In either case, the server 30 includes metadata preparation controller 56 that is configured with modules or sub-circuits to carry out operations in accordance with the method in FIG. 2. These units are pictured in FIG. 9 as a media content identifier 58, an information obtainer 60, and a metadata encoder 62.

The media content identifier 58 identifies media content that is to be available for streaming from the media server 28. The information obtainer 60 then obtains information that specifies a defined point within a presentation timeline of the identified media content at which the IPTV CS 26 is to initiate the performance of a defined operation. Responsive to the information obtainer 60, the metadata encoder 62 is then configured to encode one or more elements within metadata associated with the media content to indicate, and associate together, the defined point and defined operation.

Finally, FIG. 10 presents a more generalized view of a server 30 configured to carry out the method shown in FIG. 3. This server 30 may again have a physical configuration that corresponds directly to processing circuits 34, for example, or may be embodied in two or more modules or units. In either case, the server 30 includes a media server controller 64 that is configured with modules or sub-circuits to carry out operations in accordance with the method in FIG. 3. These units are pictured in FIG. 10 as a metadata inspector 66 and a notification controller 68.

The metadata inspector 66 inspects one or more elements within metadata associated with media content being streamed to a client device 18. Based on that inspection, the notification controller 68 determines that the server 30 is to notify the IPTV CS 26 when a defined point within a presentation timeline of the media content has been reached during streaming. Correspondingly, when that defined point has been reached, the notification controller 68 notifies the IPTV CS 26.

Those skilled in the art will of course recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A method for metadata-driven bilateral interaction between a media server and an IPTV control server (CS) during the streaming of media content from the media server to a client device, wherein the method is implemented by the IPTV CS and comprises:
receiving a notification from the media server indicating that a defined point within a presentation timeline of the media content has been reached during said streaming;
responsive to receiving said notification, inspecting one or more elements within metadata associated with the media content to identify an operation associated with said defined point;
initiating the performance of the identified operation in accordance with said metadata; and
sending the media server a response that pertains to said performance.

2. The method of claim 1, further comprising retrieving a profile stored for a user of the client device and wherein said initiating comprises initiating the performance of the identified operation based on the retrieved profile to thereby specifically tailor the identified operation to said user.

3. The method of claim 1, wherein initiating the performance of the identified operation comprises initiating the dynamic fetching of supplemental media content via a node identified within said metadata and wherein sending the media server a response comprises sending the media server the supplemental media content.

4. The method of claim 3, wherein initiating the dynamic fetching of supplemental media content comprises:
inspecting one or more other elements within said metadata to identify one or more parameters that describe the subject matter of said media content; and
passing those one or more parameters to the node identified within said metadata for the fetching of supplemental media content tailored specifically to said subject matter.

5. The method of claim 3, wherein initiating the dynamic fetching of supplemental media content comprises:
retrieving a profile stored for a user of the client device;
identifying one or more parameters in the retrieved profile that are associated with said user; and
passing those one or more parameters to the node identified within said metadata for the fetching of supplemental media content tailored specifically to said user.

6. The method of claim 1, wherein initiating the performance of the identified operation comprises initiating the sending of a notification to a node identified within said metadata.

7. The method of claim 6, wherein initiating the sending of a notification comprises initiating the sending of a notification that includes at least one of an identity of a user of the client device, an identifier of said media content, and an identity of a provider of said media content.

8. The method of claim 7, further comprising verifying the identity of said provider before initiating the sending of a notification that includes that identity.

9. An IPTV control server (CS) configured for metadata-driven bilateral interaction with a media server during the streaming of media content from the media server to a client device, wherein the IPTV CS comprises one or more network interfaces configured to communicatively couple the IPTV CS to the media server and one or more processing circuits configured to:
receive a notification from the media server, via the one or more network interfaces, indicating that a defined point within a presentation timeline of the media content has been reached during said streaming;
responsive to receiving said notification, inspect one or more elements within metadata associated with the media content to identify an operation associated with said defined point;
initiate the performance of the identified operation in accordance with said metadata; and
send the media server a response, via the one or more network interfaces, that pertains to said performance.

10. The IPTV CS of claim 9, wherein the one or more processing circuits are further configured to retrieve a profile stored for a user of the client device and to initiate the performance of the identified operation based on the retrieved profile to thereby specifically tailor the identified operation to said user.

11. The IPTV CS of claim 9, wherein the one or more processing circuits are configured to initiate the performance of the identified operation by initiating the dynamic fetching of supplemental media content via a node identified within said metadata and to send the media server a response by sending the media server the supplemental media content.

12. The IPTV CS of claim 11, wherein the one or more processing circuits are configured to initiate the fetching of said supplemental media content by:
inspecting one or more other elements within said metadata to identify one or more parameters that describe the subject matter of said media content; and
passing those one or more parameters to the node identified within said metadata for the fetching of supplemental media content tailored specifically to said subject matter.

13. The IPTV CS of claim 11, wherein the one or more processing circuits are configured to initiate the fetching of said supplemental media content by:
retrieving a profile stored for a user of the client device;
identifying one or more parameters in the retrieved profile that are associated with said user; and
passing those one or more parameters to the node identified within said metadata for the fetching of supplemental media content tailored specifically to said user.

14. The IPTV CS of claim 9, wherein the one or more processing circuits are configured to initiate the performance of the identified operation by initiating the sending of a notification to a node identified within said metadata.

15. The IPTV CS of claim 14, wherein the one or more processing circuits are configured to initiate the sending of a notification that includes at least one of an identity of a user of the client device, an identifier of said media content, and an identity of a provider of said media content.

16. The IPTV CS of claim 15, wherein the one or more processing circuits are further configured to verify the identity of said provider before initiating the sending of a notification that includes that identity.

17. A method for preparing metadata to drive bilateral interaction between a media server and an IPTV control server (CS) during the streaming of media content from the media server to a client device, wherein the method is implemented by a metadata preparation server and comprises:
identifying media content that is to be available for streaming from the media server;
obtaining information that specifies a defined point within a presentation timeline of the identified media content at which the IPTV CS is to initiate the performance of a defined operation; and
encoding one or more elements within metadata associated with the media content to indicate, and associate together, said defined point and said defined operation.

18. The method of claim 17, wherein the defined operation comprises the dynamic fetching of supplemental media content, wherein said obtaining further includes obtaining information that identifies a node via which said supplemental media content is to be fetched, and wherein said encoding further comprises encoding said one or more elements to identify said node

19. The method of claim 18, further comprising inspecting one or more other elements within said metadata to identify one or more parameters that describe the subject matter of said media content, and wherein said encoding further comprises encoding said one or more elements to indicate that said one or more parameters are to be passed to said node for the fetching of supplemental media content that is tailored specifically to said subject matter.

20. The method of claim 17, wherein the defined operation comprises the sending of a notification, wherein said obtaining includes obtaining information that identifies a node via which said notification is to be sent, and wherein said encoding further comprises encoding said one or more elements to identify said node.

21. A metadata preparation server configured to prepare metadata to drive bilateral interaction between a media server and an IPTV control server (CS) during the streaming of media content from the media server to a client device, wherein the metadata preparation server comprises one or more network interfaces configured to communicatively couple the IPTV CS to the media server and one or more processing circuits configured to:
identify media content that is to be available for streaming from the media server;
obtain information that specifies a defined point within a presentation timeline of the identified media content at which the IPTV CS is to initiate the performance of a defined operation; and
encode one or more elements within metadata associated with the media content to indicate, and associate together, said defined point and said defined operation.

22. The metadata preparation server of claim 21, wherein the defined operation comprises the dynamic fetching of supplemental media content, and wherein said one or more processing circuits are configured to obtain information that identifies a node via which said supplemental media content is to be fetched, and to encode said one or more elements to identify said node.

23. The metadata preparation server of claim 21, wherein the one or more processing circuits are further configured to inspect one or more other elements within said metadata to identify one or more parameters that describe the subject matter of said media content, and to encode said one or more elements to indicate that said one or more parameters are to be passed to said node for the fetching of supplemental media content that is tailored specifically to said subject matter.

24. The metadata preparation server of claim 21, wherein the defined operation comprises the sending of a notification, and wherein said one or more processing circuits are configured to obtain information that identifies a node via which said notification is to be sent, and to encode said one or more elements to identify said node.

25. A method for metadata-driven bilateral interaction between a media server and an IPTV control server (CS) during the streaming of media content from the media server to a client device, wherein the method is implemented by the media server and comprises:
inspecting one or more elements within metadata associated with the media content;
determining, based on said inspection, that the media server is to notify the IPTV CS when a defined point within a presentation timeline of the media content has been reached during said streaming; and
while streaming the media content to the client device, notifying the IPTV CS upon said defined point being reached.

26. The method of claim 25, further comprising receiving a response from the IPTV CS that includes supplemental media content and introducing that supplemental media content into said streaming at said defined point.
